(19) United States
(12) Patent Application Publication
(10) Pub. No.: US 2008/0023235 A1
(43) Pub. Date: Jan. 31, 2008

(54) PORTABLE AUGER WITH A TWO-STAGE HYDRAULIC PUMP

(76) Inventors: Michael J. Smollock, Gloucester, NJ (US); Stephen A. Matson, Phoenixville, PA (US)

Correspondence Address: FOX ROTHSCHILD LLP;PRINCETON PIKE CORPORATE CENTER, 997 LENOX DRIVE, BUILDING #3, LAWRENCEVILLE, NJ, 08648, US

(21) Appl. No.: 11/676,093

(22) Filed: Feb. 16, 2007

Related U.S. Application Data
(63) Continuation-in-part of application No. 10/763,797, filed on Jan. 23, 2004, now Pat. No. 7,178,615.
(60) Provisional application No. 60/442,252, filed on Jan. 24, 2003.

(51) Int. Cl. B62D 51/04

(52) U.S. Cl. 180/19.1

(57) ABSTRACT

A portable auger having a two-stage hydraulic pump is described. The two-stage pump drives an auger via an auger power drive by providing pressurized hydraulic fluid to the drive. The invention also describes a portable auger having a dedicated transport powered drive unit driven by the two-stage hydraulic pump. The transport powered drive provides powered-assisted, wheel movement of the auger by an individual. Means are also provided for allowing the wheel, or wheels, driven by the dedicated power drive unit to freewheel when the dedicated power drive unit is not in use.

### FIELD OF THE INVENTION

The present invention relates to portable augers. More specifically, the invention relates to portable augers powered by a two-stage hydraulic pump.

### BACKGROUND OF THE INVENTION

Augers are used for earth boring activities. They have to be efficient at boring or digging in a wide variety of different soil types such as dirt, gravel, and sand. For some jobs, the auger may need to be transported from site to site over different type of terrain. One or more individuals may transport the auger by wheeling it either by manpower alone or with assistance from a powered drive. Accordingly, one object of the present invention is to provide a portable auger with a power source that enables the portable auger to be transported at both slow and high speeds over varied terrain and to dig in various substances.

The portable auger may also be moved or towed by a machine, such as a truck, from site to site. If a powered drive is used, the powered drive unit must be disengaged from each wheel that it is driving to avoid damage to the drive unit when moving the auger with another machine. One object of the present invention is to provide a transport system for a portable auger that has a dedicated powered drive unit for wheeled, power-assist by an individual. Another objective of the present invention is to provide an uncomplicated means for allowing the power-driven wheels to freewheel when the portable auger is moved by another machine.

### BRIEF SUMMARY OF THE INVENTION

The portable auger made in accordance with the present invention has a frame comprising a lever tube, a frame for mounting a power system connected to one end of the lever tube and a pivot tube rigidly connected to the lever tube. An auger is pivotally connected to the end of the lever tube opposite the power system frame. The auger is connected to an auger drive powered by a power system. The power system comprises a two-stage hydraulic pump and a power source that drives the pump. The power system is pivotally attached to the power system frame which ensures that the power system maintains a horizontal orientation when raised off the ground.

An axle housing is attached to the end of the pivot tube opposite the lever tube. In some embodiments of the invention, both wheels of the portable auger are freewheeling. In such embodiments, a freewheeling axle is attached to the axle housing. The freewheeling axle includes means for attaching a wheel on each end protruding from the axle housing. Alternatively, a freewheeling axle maybe be connected to each side of the axle housing.

In other embodiments, at least one wheel of the portable auger is driven by a transport powered drive unit having a power output shaft. The transport powered unit is mounted inside the axle housing and is linked to a two-stage hydraulic pump. A powered wheel axle is connected to the power output shaft at one end and has a drive hub inserted on the other end. The drive hub may freewheel about the powered wheel axle or may be locked to the axle. A wheel is connected to the drive hub. The second wheel of a portable auger may either be power driven or freewheeling.

Other aspects of the invention are set forth in this specification.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an isometric view of one example of a structural frame used with the transport system of the present invention.

FIG. 2(a) is a top view of the structural frame illustrated in FIG. 1.

FIG. 2(b) is a side view of the structural frame illustrated in FIG. 1.

FIG. 2(c) is a front view of the structural frame illustrated in FIG. 1.

FIG. 3(a) is a rear/operator position view of one example of an axle housing, with associated components, that is used with the transport system of the present invention.

FIG. 3(b) is a right side view of the axle housing illustrated in FIG. 3(a).

FIG. 3(c) is a left side view of the axle housing illustrated in FIG. 3(a).

FIG. 4 is a bottom view of the axle housing illustrated in FIG. 3(a).

FIG. 5(a) is a bottom isometric view of the axle housing illustrated in FIG. 3(a).

FIG. 5(b) is an exploded bottom isometric view of the axle housing illustrated in FIG. 3(a).

FIG. 6(a) and FIG. 6(b) are another example of a transport system of the present invention.

FIG. 8 is a left side view of the assembled portable auger of the present invention.

FIG. 9 is a right side view of the assembled portable auger of the present invention.

FIG. 10 is a rear view of the assembled portable auger of the present invention.

FIG. 11 is a front view of the assembled portable auger of the present invention.

### DETAILED DESCRIPTION OF THE INVENTION

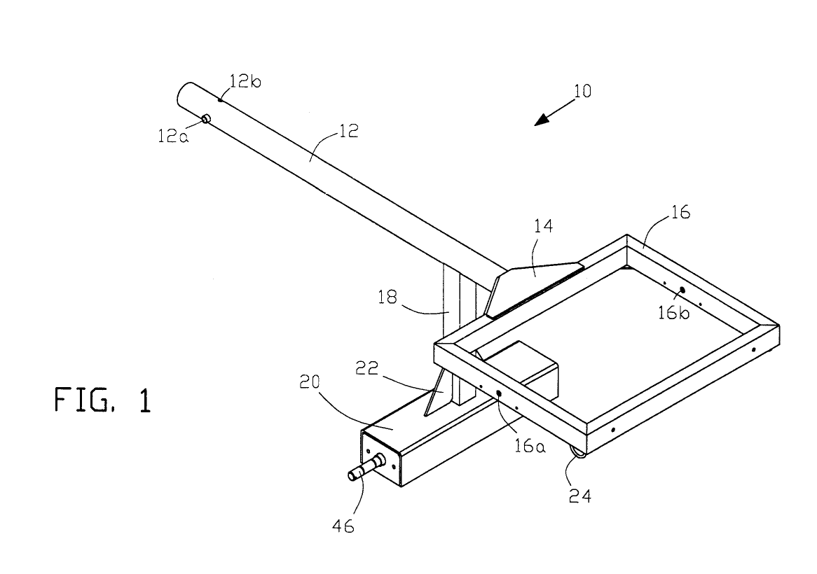

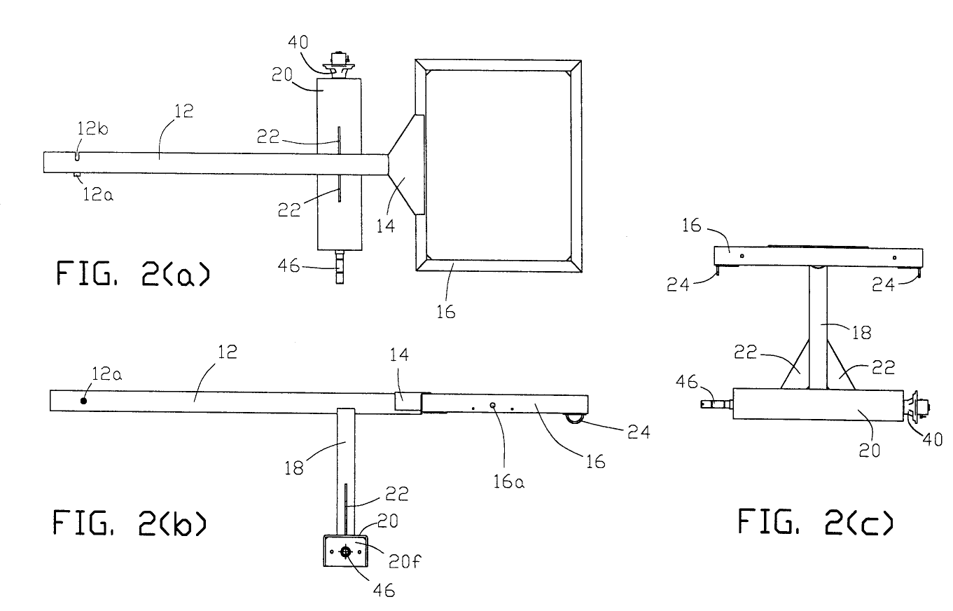

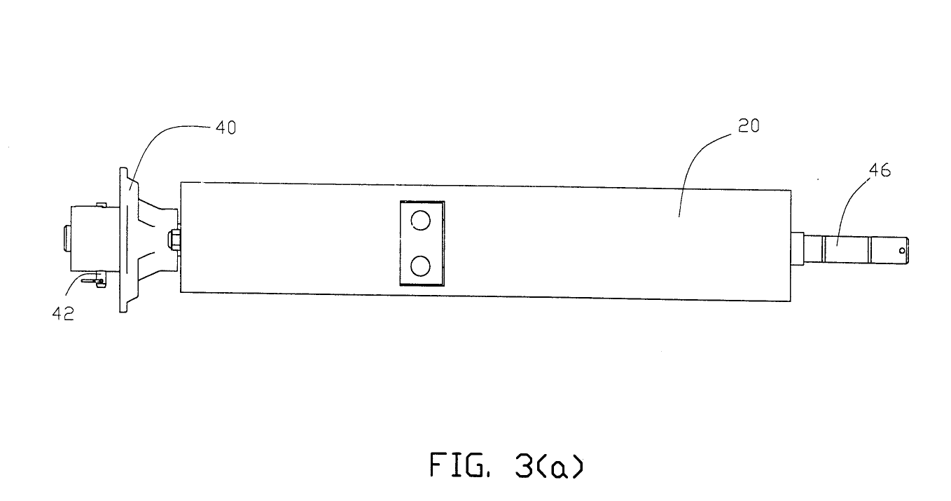

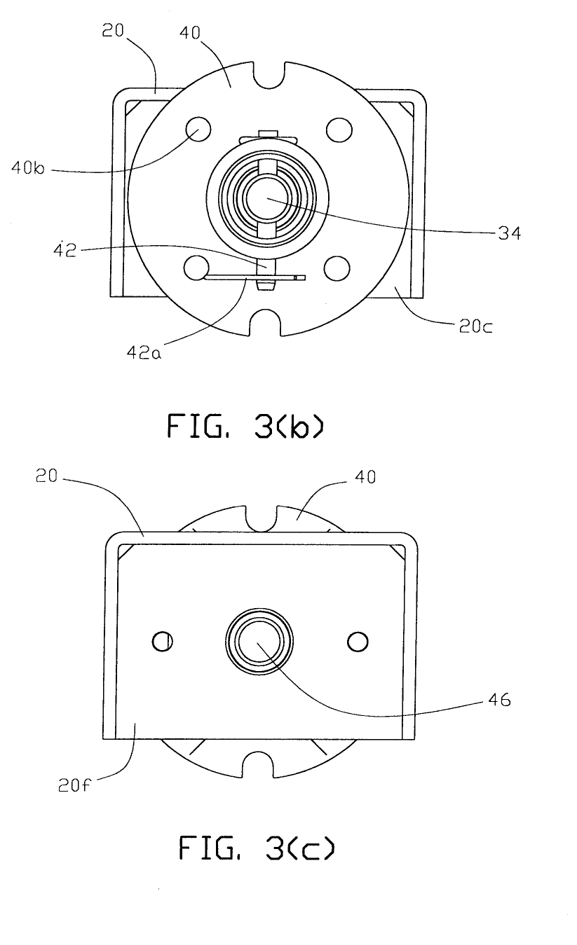

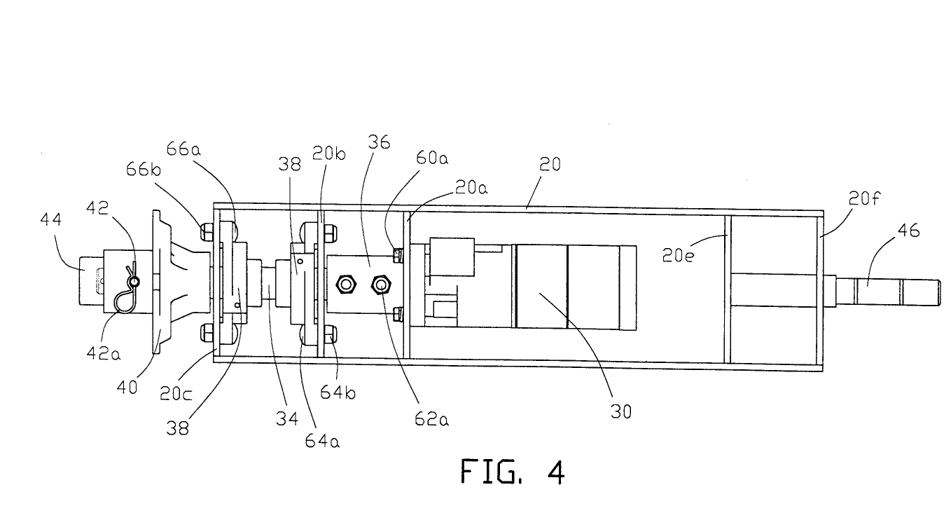

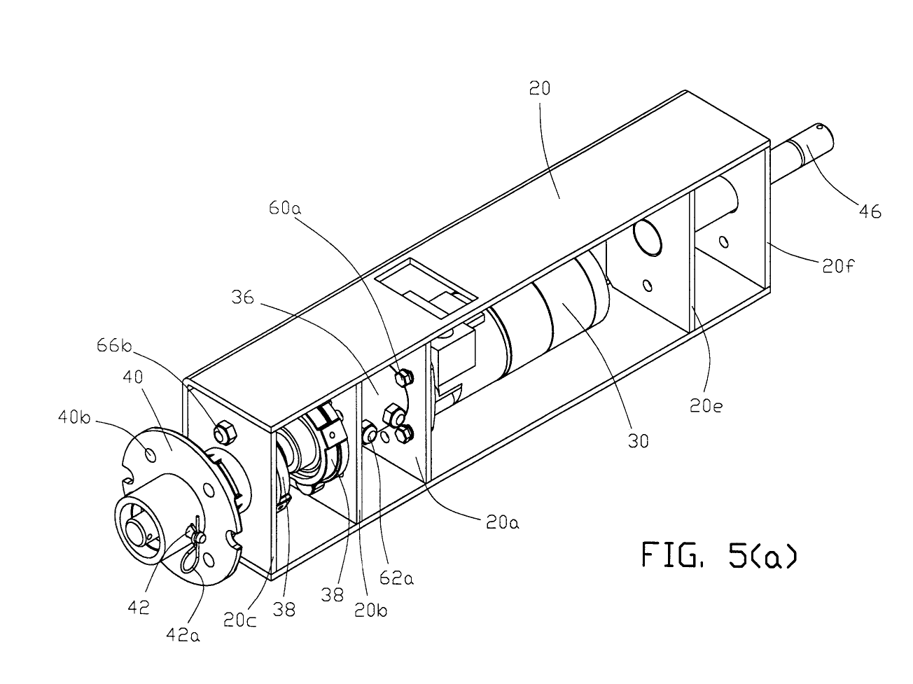

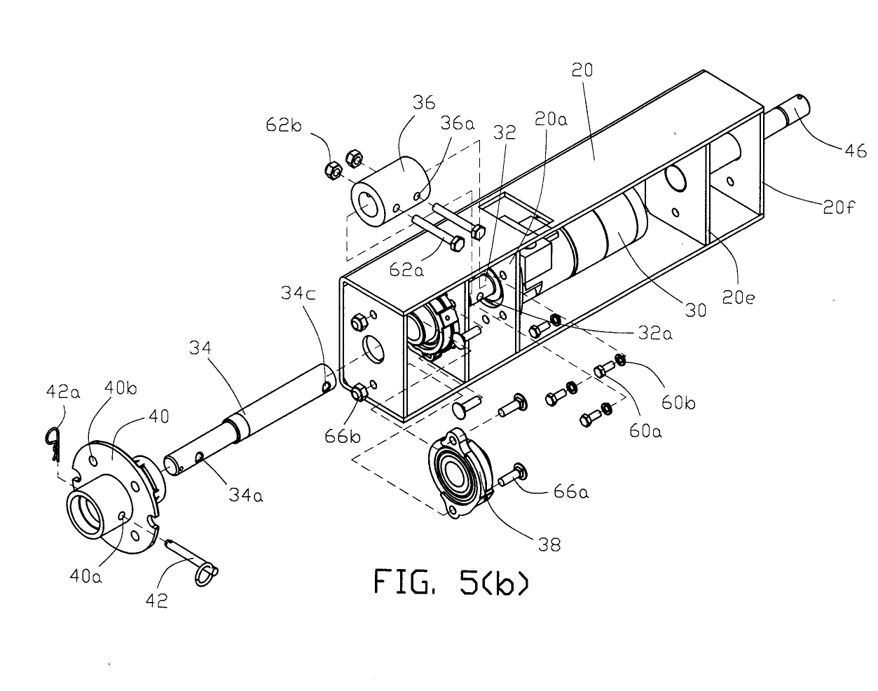

Referring now to the drawings, wherein like numerals indicate like elements, there is shown in the figures one example of the transport system for a portable auger of the present invention. In FIG. 1, and FIG. 2(a) through FIG. 2(c), transport system 10 is shown without auger, power source and wheels attached. Lever tube 12 is suitably attached (e.g. by weld) to frame brace 14 and power source frame 16. Frame bracket 14 is suitably attached to power source frame 16. A power source (now shown) is suitably attached to frame 16. For example the power source may be pivotally connected to frame 16 via openings 16a and 16b so that the base of the power source will maintain a horizontal orientation when the portable auger is pivoted about its wheels as further described below. Center pivot tube 18 is suitably connected at one end to lever tube 12 and at the opposing end to axle housing 20. Pivot tube gussets 22, suitably attached to center pivot tube 18 and the top of axle housing 20 may be provided for additional strength at the center pivot tube and axle housing point of connection. The auger (now shown) may be pivotally attached to the lever tube 12 by insertion of a handle into the lever tube. For example, raised hole 12a and opening 12b can be used to provide a quick connect/disconnect means for locking the inserted handle in place. The auger can be pivotally attached to the handle. A wheel (now shown) is attached to an axle protruding form each end of the axle housing as further described below.

One or more chain brackets 24 are suitably attached to the front end of power source frame 16. In other examples of the invention, a tow bar is attached to the front end of the power source frame. When towed by another machine, such as a truck, a connecting means, such as a chain, can be attached between the truck and chain brackets 24 or tow bar. In tow mode, the portable auger is generally oriented in the horizontal position shown in FIG. 2(b). An individual can move the portable auger by sufficiently lowering the end of lever tube 12 to which the auger is attached so that the power source is raised off of the ground. Transport drive controls can be mounted near the same end of the lever tube so that the operator can activate and deactivate the transport powered drive unit that is mounted in axle housing 20 as further described below. The auger (now shown) when not in use, for example, during tow or movement by an individual, is generally stowed adjacent to the center pivot tube by pivoting the auger about is connection point to the center pivot tube. For use of the auger, the end of the center pivot tube to which the auger is attached is allowed to raise up until the power source (serving as a counterweight) rests on the ground, and the auger is pivoted down from its stowed position to a generally vertical orientation with respect to the auger's axial length. Auger drive controls 84 can be mounted near the end of the lever tube to which the auger is attached so that the operator can activate and deactivate the auger drive that can be mounted to the top of the axial length of the auger.

Axle housing 20 has a number of housing plates suitably attached to it (e.g., by welding) for mounting associated components. In some embodiments of the present invention, freewheeling axles 46a and 46b are suitably connected to the housing plates at each end of the axle housing 20. The wheels (not shown) are attached to freewheeling axles 46a and 46b. Alternatively, a single freewheeling axle may be used.

In the preferred embodiment, a transport powered drive unit 30 is suitably mounted to the axle housing. For example, as shown in the figures, transport powered drive unit 30 is suitably mounted to the axle housing. For example, as shown in the figures, transport powered drive unit 30 is attached to axle housing plate 20a by screws and lock washers 60a and 60b, respectively. Output shaft 32 of the transport powered drive unit is rigidly connected to powered w heel axle 34 by suitable means. For example, as shown in the figures, connecting sleeve 36 slips over mating ends of output shaft 32 and axle 34. Screws 62a pass through holes 36a, 32a and 34c, in the connecting sleeve, output shaft and axle, respectively and mate with nuts 62b to hold the output shaft and axle rigidly together. In this non-limiting example of the invention a pair of flange bearing assemblies 38 are used to support drive wheel axle 34. The inner bearing assembly is attached to axle housing plate 20b by screws and nuts 64a and 64b, respectively. Outer bearing assembly is attached to axle housing plate 20c by screws and nuts 66a and 66b, respectively. Plate 20c also serves as an end plate of the axle housing in this example of the invention. Drive hub 40 is suitably attached to the end of drive wheel axle 34 so that it will freewheel if hub locking pin 42 is not inserted through holes 40a in the drive hub and hole 34a in the drive wheel axle. One means of attaching drive hub 40 to the end of drive wheel axle 34 is by use of a nut 44 threaded onto drive wheel axle 34, as shown in FIG. 4. The nut must be screwed on to the end of the drive wheel axle. A wheel (now shown) is secured to drive hub 40 via inserting suitable fasteners through holes 40b, which are radially disposed around an inner circumference of the drive hub. In this example of the invention, the wheel (not shown) at the opposite end of the axle housing is not power driven and is always freewheeling. This wheel is suitably attached to free wheeling axle 46. When the wheel connected to drive hub 40 is not power driven by transport power drive unit 30, hub locking pin 42 must be removed from hub 40 and drive wheel axle 34.

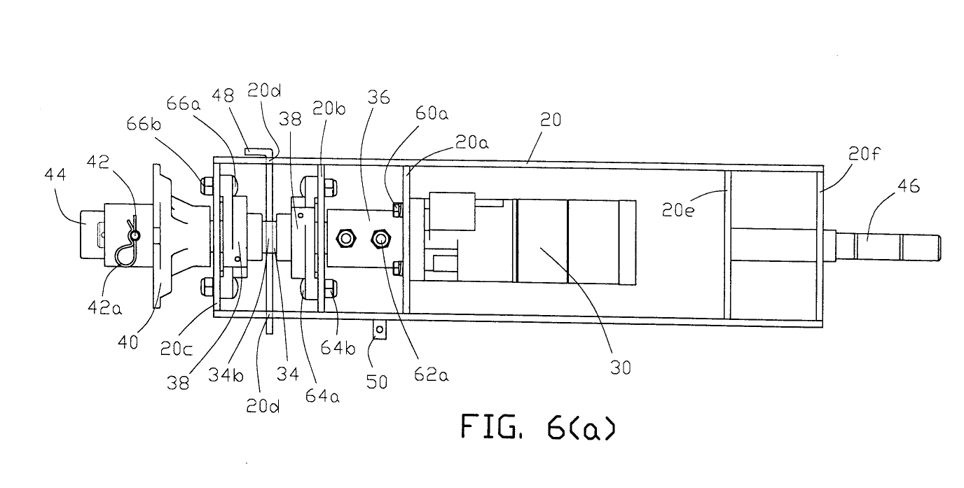

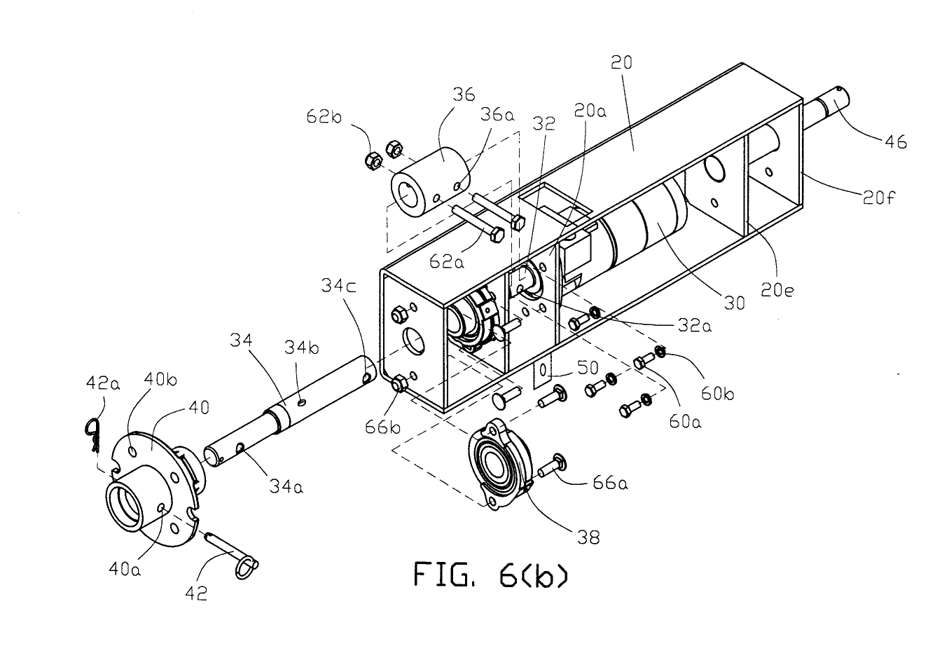

In another example of the invention, in addition to the drive hub locking and unlocking means, separate means may be provided for securely locking the output of the transport powered drive unit. As illustrated in FIG. 6(a) and FIG. 6(b), drive axle pin 48 is inserted through openings 20d in axle housing 20 and opening 34b in drive wheel axle 34 to lock the drive w heel axle, and the output shaft 32 of transport powered drive unit 30 to which it is attached. In alternative examples of the invention, rather than locking through a hole in the drive wheel axle, a hole may be provided in the output shaft for direct locking of the output shaft.

In operation, when transport system 10 is being wheeled by an individual with powered assist from the transport powered drive unit, hub locking pin 42 is inserted through openings 40a in drive hub 40 and opening 34a in drive wheel axle 34. The hub locking pin may be secured in this position by using a suitable fastener, such as cotter pin 42a.

If the optional means for locking the output of the transport powered drive unit is provided, when the transport powered drive unit is being used, drive axle pin 48 is not inserted through openings 20d in axle housing 20 and opening 34b in drive wheel axle 34, and the drive axle pin may be attached by a chain, or similar fastener, to the axle housing and stowed in a hole in a tow bar, if used, or in optional pin holder 50.

In operation, when the transport powered drive unit is not being used, hub locking pin 42 is not inserted through openings 40a in drive hub 40 and opening 34a in drive wheel axle 34. Hub locking pin 42, and its fastener, if used, may be attached by a chain, or other suitable fastener, to the axle housing, and stowed in a hole in a tow bar, if used, or in an optional pin holder on the structural frame of the transport system.

If the optional means for locking the output of the transport powered drive unit is provided, when the transport powered drive unit is not being used, drive axle pin 48 is inserted through openings 20d in axle housing 20 and opening 34b in drive wheel axle 34.

In the present example of the invention, only one of the two wheels used in the transport system is power driven by the transport powered drive unit. Alternatively, both wheels may be power driven, and a drive axle pin and hub locking pin can be provided for each of the two power driven wheels.

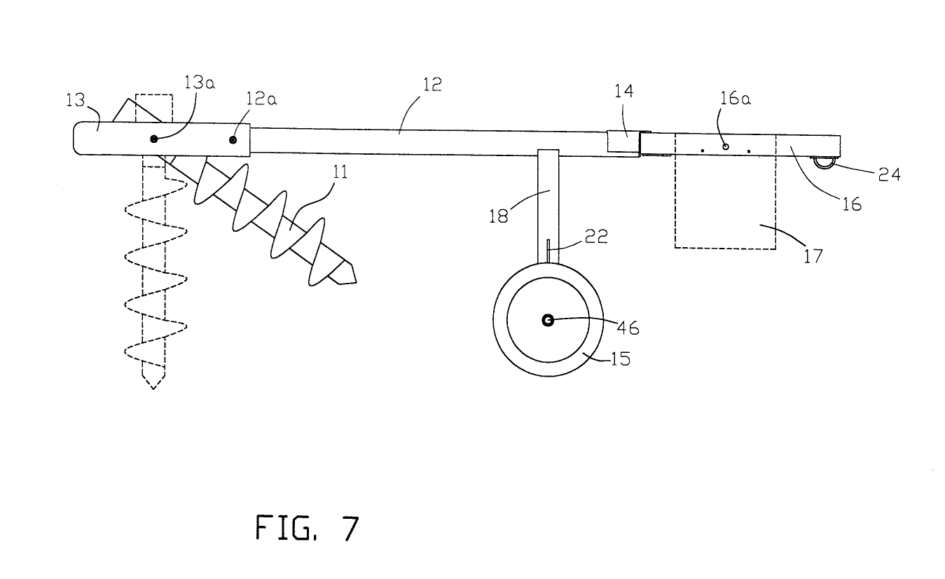

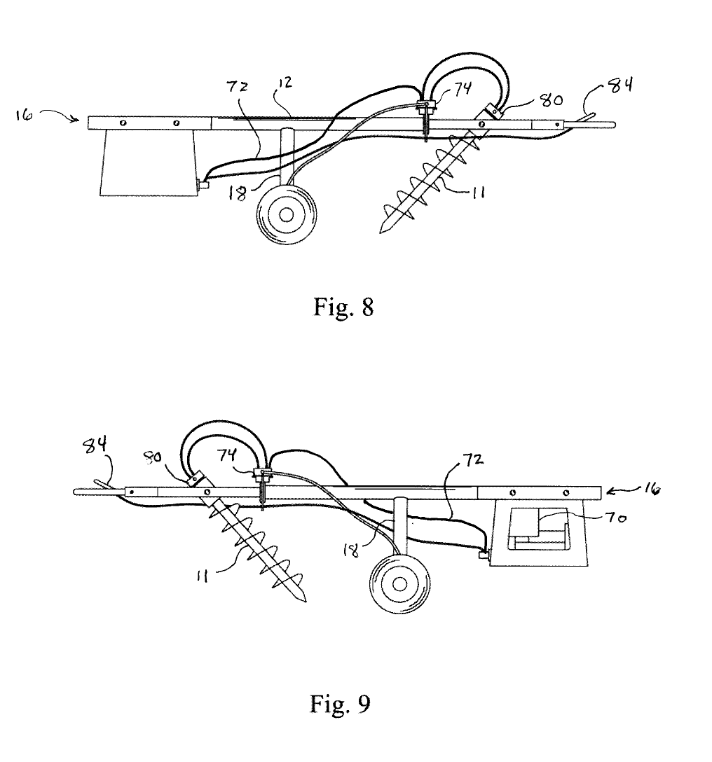

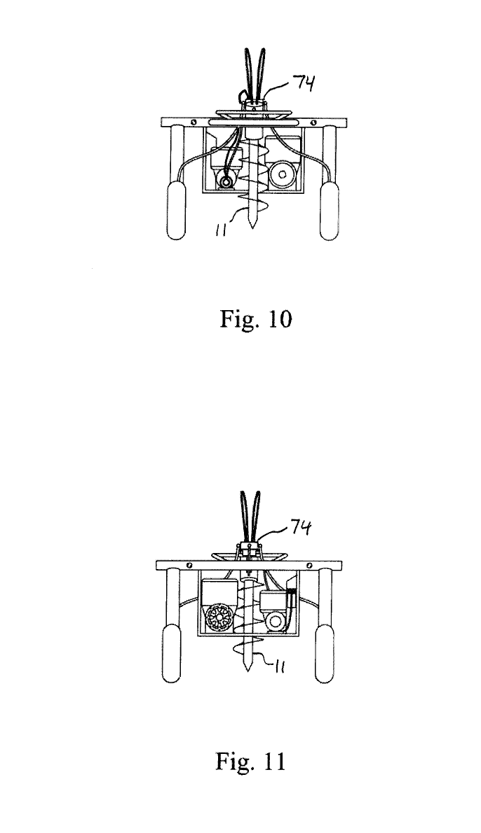

The utilized power system may be any power system that can be self-contained on the transport frame, such as an electrical or hydraulic system. In the preferred example of the invention, the power system is hydraulic. As shown in FIG. 10, the power system comprises a hydraulic pump 70 driven by a power source unit 82. The hydraulic pump 70 provides pressurized hydraulic fluid to a distribution valve 74 via a suitable hose 72, as shown in FIG. 8 and FIG. 9. The distribution valve 74 is connected to an auger powered drive unit 80. In the embodiments of the present invention where the wheels are power driven, the distribution valve 74 is also connected to the transport powered drive unit 30. The pressurized fluid supplied by the pump 70 is distributed among the auger powered unit 80 and the transport powered unit 30. An operator can control the distribution valve 74 by the auger drive controls 84.

Preferably, the hydraulic pump 70 is a two stage hydraulic pump. A high torque may be required when the portable auger is used to dig in a hard soil or if it is transported uphill. When high torque is required, both stages of the pump can be employed to supply adequate pressure. On the other hand, a single stage of the pump is used when a lower torque is sufficient. The variable capacity of the two-stage pump provides flexibility and improves fuel economy and performance.

The foregoing examples do not limit the scope of the disclosed invention. The scope of the disclosed invention will be further covered in the claims of an application claiming priority of this document.

What is claimed is:

1. A portable auger comprising:
a lever tube having a first lever tube end and a second lever tube end;
a power source frame for mounting of a power system, the first lever tube end rigidly connected to the power source frame;
an auger pivotally attached to the second lever tube end;
an auger powered drive unit connected to the auger;
a pivot tube having a first pivot tube end and a second pivot tune end, the first pivot tube end rigidly connected to the first lever tube end;
an axle housing, having a first axle housing end and a second axle housing end, the second pivot tube end rigidly connected to the axle housing;
a transport powered drive unit having a power output shaft, the transport powered drive unit mounted internal to the axle housing;
a powered wheel axle having a first powered wheel axle end and a second powered wheel axle end, the first powered wheel axle end suitably connected to the power output shaft, the second powered wheel axle end protruding from the first axle housing end;
a drive hub inserted on the second powered wheel axle end, the drive hub suitably attached to the second powered wheel axle end to freewheel about the powered wheel axle, the drive hub having a means for attachment of a first wheel;
a means for selectively locking the drive hub to the powered wheel axle to prevent the drive hub from freewheeling about the powered wheel axle; and
a freewheeling axle having a first freewheeling axle end and a second freewheeling axle end, the first freewheeling axle end connected to the second axle housing end, the second freewheeling housing end having means for attachment of a second wheel.
a two-stage hydraulic pump linked to the auger powered drive unit and to the transport powered drive unit.

2. The portable auger of claim 1 wherein the means for selectively locking the drive hub to the powered wheel axle comprises an opening in the powered wheel axle; and opening in the drive hub; and a hub locking pin, whereby insertion of the hub locking pin in the openings in the powered wheel axle and the drive hub locks the drive hub to the powered wheel axle.

3. The portable auger of claim 2 further comprising a means for locking the power output shaft to prevent rotation of the power output shaft.

4. The portable auger of claim 3 wherein the means for locking the power output shaft comprises an opening in the powered wheel axle; an opening in the axle housing and a drive axle pin, whereby insertion of the drive axle pin in the openings in the axle housing and the powered wheel axle locks the power output shaft.

5. The portable auger of claim 3 wherein the means for locking the power output shaft comprises an opening in the power output shaft; an opening in the axle housing and a drive axle pin, whereby insertion of the drive axle pin in the openings in the axle housing and the power output shaft locks the power output shaft.

6. The portable auger of claim 1 wherein the power system is pivotably mounted to the power source frame, whereby the power source maintains a horizontal orientation when the lever tube is pivoted about the powered wheel axle and the free wheel axle.

7. The portable auger of claim 1 wherein the first powered wheel axle end is suitably connected to the power output shaft by a connecting sleeve, the connecting sleeve suitably fastened to the first powered wheel axle end and the power output shaft.

8. The portable auger of claim 1 wherein the auger powered drive unit operates in forward and reverse directions.

9. A portable auger comprising:
a lever tube having a first lever tube end and a second lever tube end;
an auger pivotally attached to the second lever tube end;
an auger powered drive unit connected to the auger;
a power source frame for mounting of a power system, the first lever tube end rigidly connected to the power source frame,
a pivot tube having a first pivot tube end and a second pivot tune end, the first pivot tube end rigidly connected to the first lever tube end;
an axle housing rigidly connected to the second pivot tube end; and
a two-stage hydraulic pump linked to the auger powered drive unit.

10. The portable auger of claim 9 further comprising
a first freewheeling axle having a first end and a second end, the first end of the first freewheeling axle end connected to the axle housing end, the second end of the first freewheeling axle having means for attachment of a wheel; and
a second freewheeling axle having a first end and a second end, the first end of the second freewheeling axle end connected to the axle housing end, the second end of the second freewheeling axle having means for attachment of a wheel.

11. The portable auger of claim 9 further comprising a freewheeling axle attached to the axle housing having means for attachment of a wheel at each end.

12. The portable auger of claim 9 wherein the power system is pivotably mounted to the power source frame, whereby the power source maintains a horizontal orientation when the lever tube is pivoted about the powered wheel axle and the free wheel axle.

13. The portable auger of claim 9 wherein the auger powered drive unit operates in forward and reverse directions.
